(19) United States
(12) Patent Application Publication
(10) Pub. No.: US 2009/0207215 A1
(43) Pub. Date: Aug. 20, 2009

(54) TOOL FOR ASSISTING THE REMOVAL FROM AN INK JET PRINTER OF A CONTAINER USED TO SUPPLY FLUID TO THE PRINTER

(76) Inventor: Ian Michael Fost, Cambridgeshire (GB)

Correspondence Address: MCANDREWS HELD & MALLOY, LTD, 500 WEST MADISON STREET, SUITE 3400, CHICAGO, IL, 60661, US

(21) Appl. No.: 11/719,186

(22) PCT Filed: Nov. 10, 2005
(86) PCT No.: PCT/EP05/12077

§ 371 Date: Mar. 4, 2009

(30) Foreign Application Priority Data
Nov. 13, 2004 (GB) 0425079.1

(51) Int. Cl. B41J 2/175; B25B 27/00

(52) U.S. Cl. 347/85; 29/267; 29/270

(57) ABSTRACT

A tool (1) for assisting the removal from an ink jet printer of a container (51) used to supply fluid to the printer, in use said tool (1) being interposed between said printer and said container (51), said tool (1) including a raised portion (11) which on movement of said tool (1) from a first to a second position acts so as to push said container (51) away from said printer, said movement from a first to a second position involving rotation of said tool (1) in a plane between said printer and said container (51), which plane is generally perpendicular to the direction in which said container (51) delivers fluid to said printer.

This invention relates to a tool for assisting the removal from an ink jet printer of a container used to supply fluid to the printer.

U.S. Pat. No. 6,158,854 discloses an ink jet printer including a container for supplying ink/ink solvent to the printer. The container supplies the ink/solvent by way of a coupling between the container and printer. The coupling comprises a male connector part carried by the container, and a female connector part carried by the printer. An O-ring seals between the male and female connector parts. First and second sloped protrusions are provided on opposite sides of the opening in the female connector part. When the coupling is made the first and second sloped protrusions are received in respective first and second sloped recesses formed in the main body of the container on opposite sides of the male connector part. The sloped surfaces of the protrusions lie against the sloped surfaces of the recesses when the container is installed in the printer. Removal of the container and breaking of the seal between the male and female connector parts is achieved by manually rotating the container. This causes the abutting sloped surfaces to ride over one another and in doing so push the container away from the printer.

U.S. Pat. No. 6,158,854 has the disadvantage that the exterior of the printer must not obstruct rotation of the container to remove the container. This places a limitation on the design of the printer. Further, the manual grasping of the container to rotate it may, if not carefully done, put undue strain on the O-ring seal causing damage to the seal.

According to the present invention there is provided a tool for assisting the removal from an ink jet printer of a container used to supply fluid to the printer, in use the tool being interposed between the printer and the container, the tool including a raised portion which on movement of the tool from a first to a second position acts so as to push the container away from the printer, the movement from a first to a second position involving rotation of the tool in a plane between the printer and the container, which plane is generally perpendicular to the direction in which the container delivers fluid to the printer.

The raised portion suitably comprises first and second sloped protrusions, in use of the tool the protrusions being spaced apart in the aforesaid plane and disposed on opposite sides of an opening in the container for dispensing the fluid.

The tool suitably comprises a generally planar main part and a handle for use of the tool extending from the main part, the main part including an opening which in use of the tool is aligned with the opening in the container, the main part also including the aforesaid protrusions which are disposed on opposite sides of the opening in the main part.

The present invention also provides an ink jet printer including mounted thereon a tool according to the present invention for assisting the removal from the printer of a container used to supply fluid to the printer.

Preferably, the printer includes a construction suitable for preventing movement of the container with the tool as the tool is moved from the aforesaid first to second positions.

The construction suitably comprises first and second sub-constructions located on opposite sides of an opening in the printer for receiving the fluid, engagement of the container with the sub-constructions preventing the movement of the container with the tool.

Each sub-construction suitably comprises a pair of adjacent projections defining a channel therebetween.

The present invention further provides a printer as envisaged in the previous paragraph including installed therein the container, the container including first and second projections, which projections are located in respective aforesaid channels, in use of the tool the raised portion of the tool pushing against the projections of the container to push the container away from the printer.

The invention will now be described, by way of example, with reference to the accompanying drawings, in which:

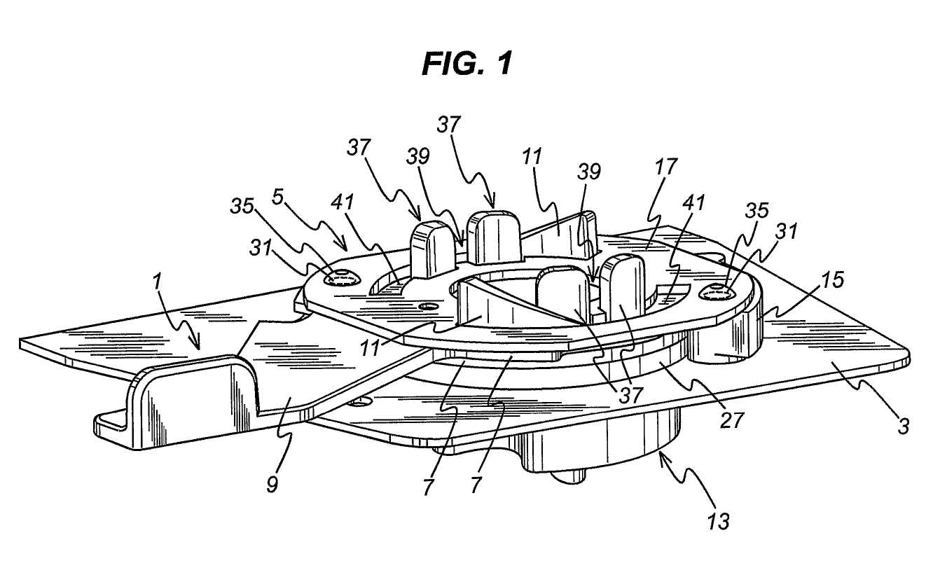

FIG. 1 illustrates a tool in accordance with the present invention mounted on a printer;

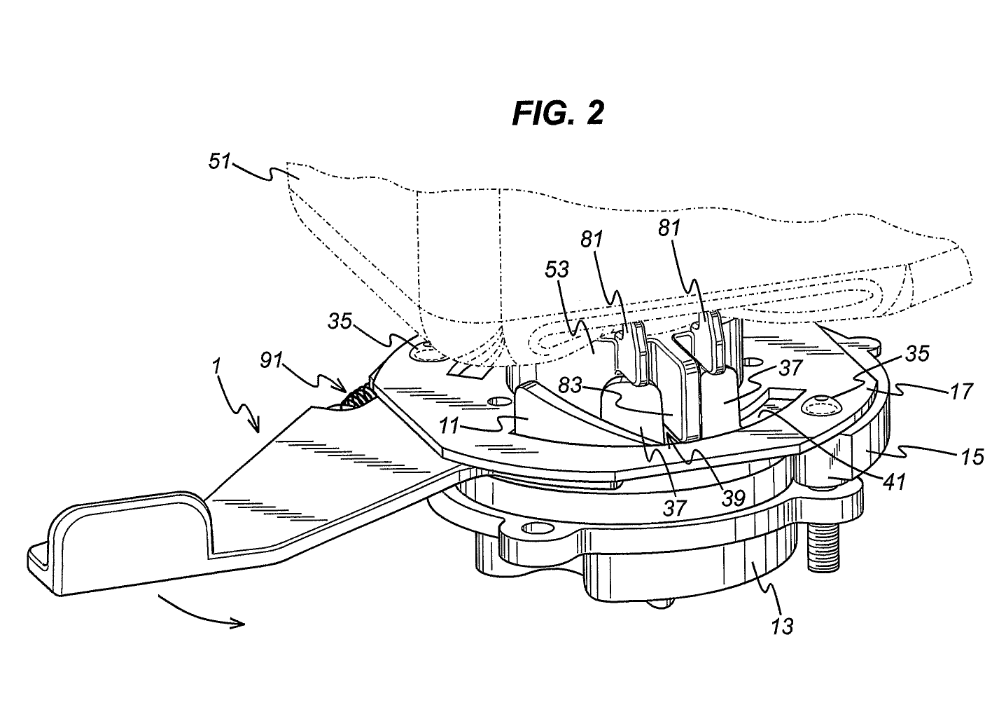

FIG. 2 illustrates the installation of a container utilising the mounting of FIG. 1;

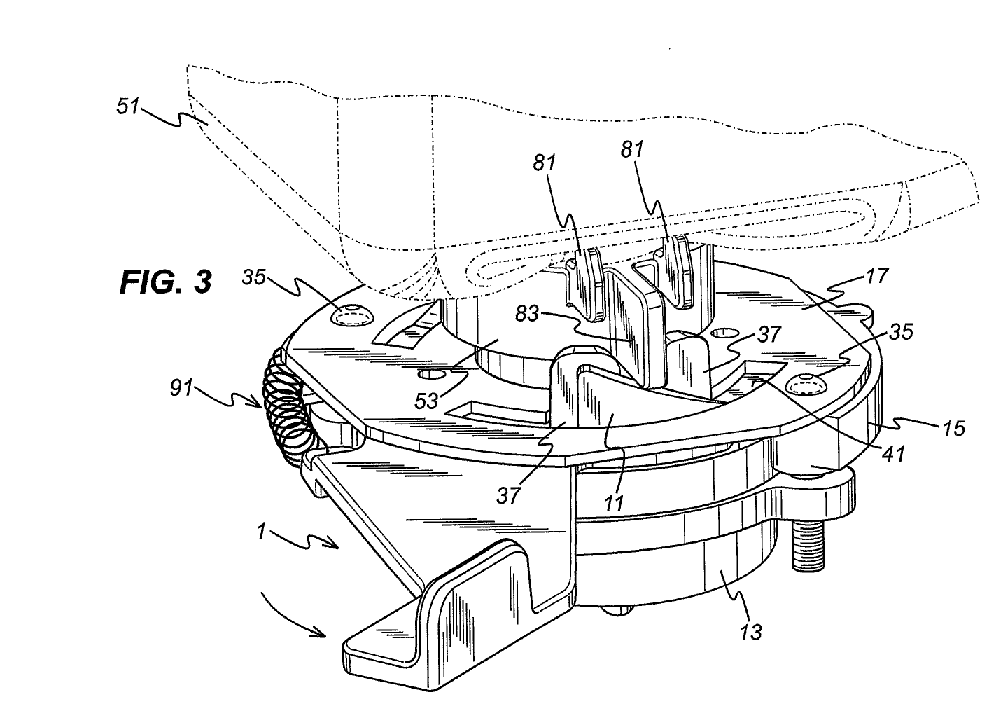

FIG. 3 illustrates the removal of an installed container utilising the tool of FIG. 1;

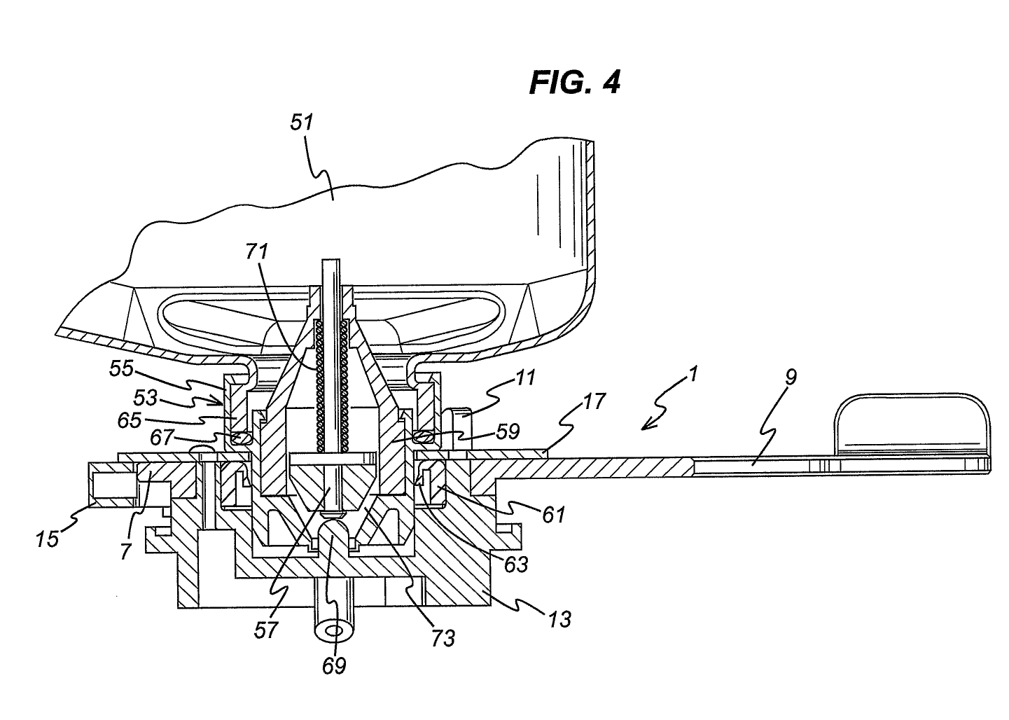

FIG. 4 is a section through the tool, mounting and installed container of FIG. 2;

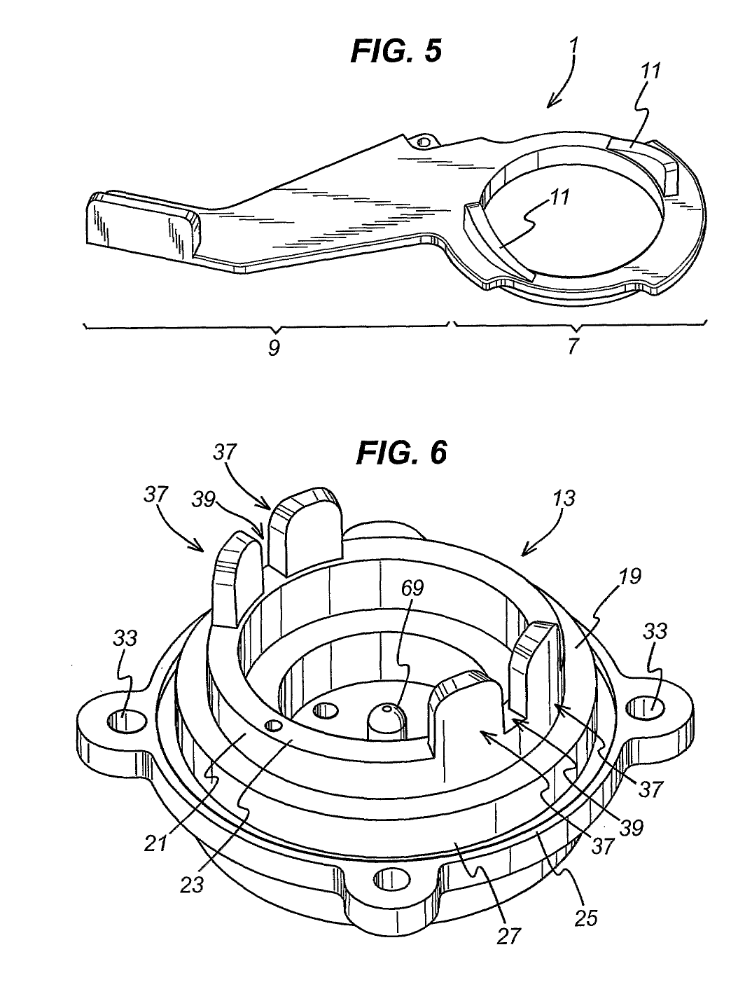

FIG. 5 illustrates the tool of FIG. 1 removed from its mounting on the printer;

FIGS. 6, 7 and 8 illustrate respectively first, second and third constituent parts of the mounting of FIG. 1; and

FIG. 9 illustrates an outer casing of a male connector part of the container of FIG. 2.

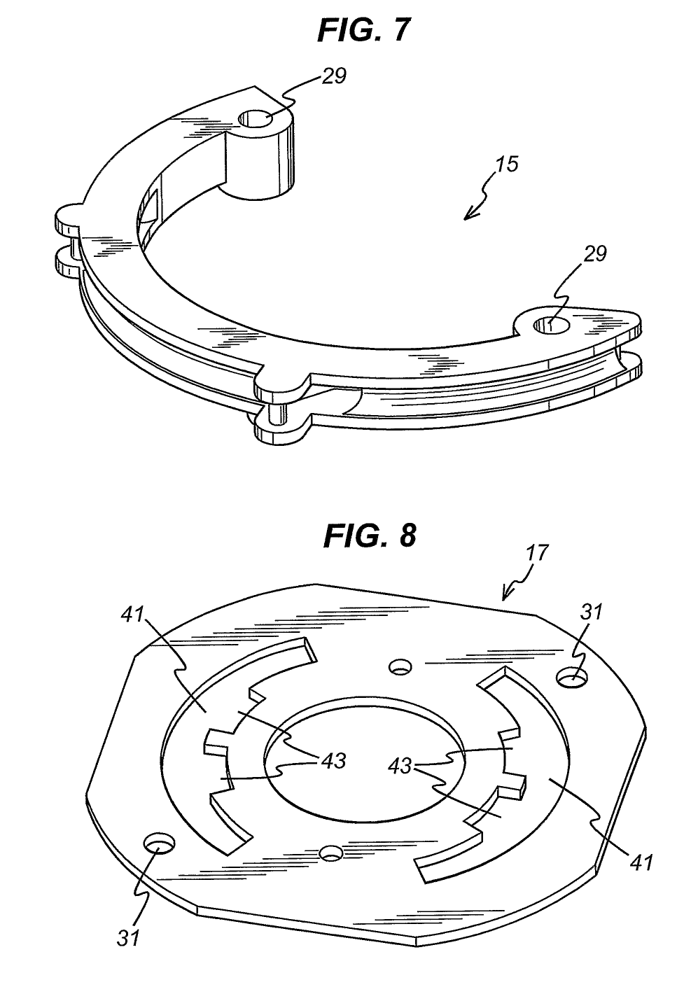

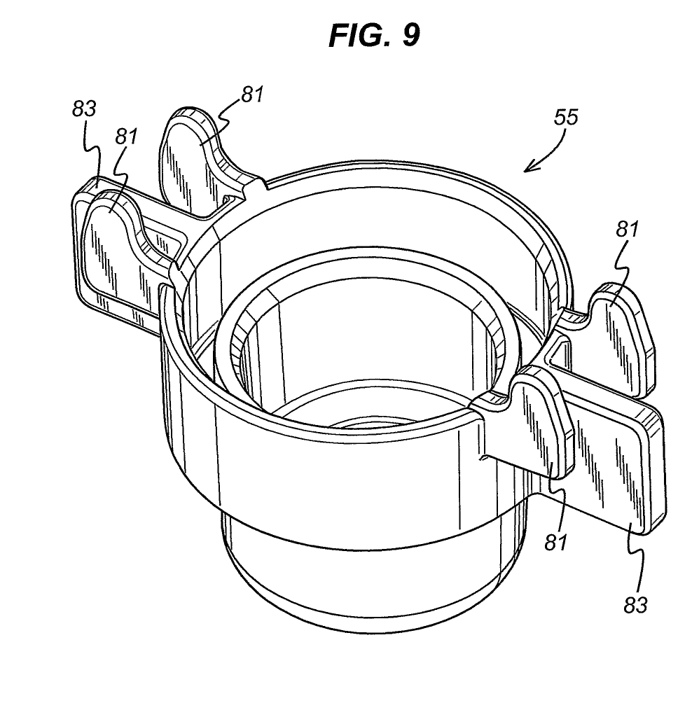

Referring to FIG. 1, a tool 1 is mounted on a top plate 3 of an ink jet printer by means of a mounting 5. Referring also to FIG. 5, tool 1 comprises a generally planar, annular main part 7, and a handle 9 for use of the tool extending from main part 7. Annular main part 7 includes first and second sloped protrusions 11 disposed on opposite sides of the opening of the annular part. Each protrusion 11 slopes from no projection from the plane of main part 7 to a maximum projection. Referring also to FIGS. 6, 7 and 8, mounting 5 comprises a female connector part 13 as shown in FIG. 6, an arcuate stop member 15 as shown in FIG. 7, and a mounting plate 17 as shown in FIG. 8. Annular main part 7 of tool 1 rests on ledge 19 of female connector part 13, and encircles and abuts the exterior of wall 21 of part 13. Mounting plate 17 rests on the top 23 of wall 21. Top plate 3 of the printer rests on ledge 25 of connector part 13, and encircles and abuts wall 27 of part 13. Arcuate stop member 15 is disposed between mounting plate 17 and top plate 3 of the printer, and extends halfway around female connector part 13 and annular main part 7 of tool 1. Boreholes 29 at either end of arcuate member 15 align with diametrically opposite boreholes in mounting plate 17, top printer plate 3, and female connector part 13. The diametrically opposite boreholes in mounting plate 17 are referenced 31, and in female connector part 13 are referenced 33. Bolts 35 extend through the boreholes to secure the assembly together. Diametrically opposite first and second pairs of adjacent projections 37 protrude from top 23 of wall 21 of female connector part 13. Each pair of projections 37 defines therebetween a channel 39. Formed in mounting plate 17 is a pair of opposite arcuate slots 41, and cut into the shorter side of each arcuate slot 41 is a pair of recesses 43. In the assembly, arcuate slots 41 accommodate sloped protrusions 11 of tool 1, and recesses 43 accommodate pairs of adjacent projections 37 of female connector part 13.

Referring to FIG. 4, an installed container 51 includes a male connector part 53 fitted at the fluid dispensing opening of container 51. Male connector part 53 comprises an outer casing 55, a valve armature 57, and a valve surround 59. A spring 71 surrounds armature 57. A neck 65 of container 51 surrounds its fluid dispensing opening. An O-ring 67 seals between neck 65 and outer casing 55 of male connector part 53. Male connector part 53 is received by female connector part 13 of mounting 5 on the printer. A ring seal 61 seals between male and female connector parts 53, 13. Ring seal 61 includes a lip 63 which bears against male connector part 53. A stub protrusion 69 at the centre of female connector part 13 (see also FIG. 6) engages valve armature 57 so as to push it in an upwards direction against the action of spring 71. This creates annular opening 73 allowing fluid to pass to the printer. It is to be noted in this regard that the resistance of ring seal 61 must be greater than the force of spring 71.

Referring to FIG. 9, first and second pairs of adjacent clips 81 are located on opposite sides of outer casing 55 of the male connector part. Disposed between the adjacent clips of each pair is a generally rectangular, planar projection 83. Referring also to FIG. 2, clips 81 clip onto container 51 to assist in securing male connector part 53 to the container. Projections 83 slot into corresponding channels 39 defined between the adjacent projections of the first and second pairs of projections 37 of female connector part 13 of mounting 5 on the printer.

FIG. 2 shows container 51 fully installed in the printer. Thus, tool 1 is positioned such that its first and second sloped protrusions 11 are located at extreme ends of arcuate slots 41 of mounting plate 17. When so located sloped protrusions 11 do not interfere with planar projections 83 of male connector part 53. A spring 91 biases tool 1 to its position shown in FIG. 2.

Referring to FIG. 3, removal of container 51 is achieved by rotating tool 1 so as to cause sloped protrusions 11 to travel along arcuate slots 41 such that the sloped surfaces of protrusions 11 engage planar projections 83 thereby lifting projections 83. In this regard it is to be noted that the projections 37 on the side of planar projections 83 remote from sloped protrusions 11 prevent rotation of container 51 and thereby facilitate lifting of the container. As can be seen from FIG. 4, lifting of container 51 is against the resistance of ring seal 61 and causes valve armature 57 to be lifted off stub protrusion 69 thereby allowing spring 71 to close annular opening 73 preventing fluid leaving container 51.

1. A tool (1) for assisting the removal from an ink jet printer of a container (51) used to supply fluid to the printer, in use said tool (1) being interposed between said printer and said container (51), said tool (1) including a raised portion (11) which on movement of said tool (1) from a first to a second position acts so as to push said container (51) away from said printer, said movement from a first to a second position involving rotation of said tool (1) in a plane between said printer and said container (51), which plane is generally perpendicular to the direction in which said container (51) delivers fluid to said printer.

2. A tool (1) according to claim 1 wherein said raised portion (11) comprises first and second sloped protrusions (11), in use of said tool (1) said protrusions (11) being spaced apart in said plane and disposed on opposite sides of an opening in said container (51) for dispensing said fluid.

3. A tool (1) according to claim 2 comprising a generally planar main part (7) and a handle (9) for use of the tool (1) extending from said main part (7), said main part (7) including an opening which in use of the tool (1) is aligned with said opening in said container (51), said main part (7) also including said protrusions (11) which are disposed on opposite sides of said opening in the main part (7).

4. A tool (1) according to claim 3 wherein each said protrusion (11) slopes from no projection from the plane of said main part (7) to a maximum projection.

5. An ink jet printer including mounted thereon a tool (1) according to any one of claims 1 to 4.

6. A printer according to claim 5 including a construction (37) suitable for preventing movement of said container (51) with said tool (1) as the tool (1) is moved from said first to said second position.

7. A printer according to claim 6 wherein said construction (37) comprises first and second sub-constructions (37) located on opposite sides of an opening in said printer for receiving said fluid, engagement of said container (51) with said sub-constructions (37) preventing said movement of the container (51) with the tool (1).

8. A printer according to claim 7 wherein each said sub-construction (37) comprises a pair of adjacent projections (37) defining a channel (39) therebetween.

9. A printer according to claim 8 including installed therein said container (51), said container (51) including first and second projections (83), which projections (83) are located in respective said channels (39), in use of said tool (1) said raised portion (11) pushing against said projections (83) of the container (51) to push the container (51) away from the printer.
